(19) United States
(12) Patent Application Publication
(10) Pub. No.: US 2009/0124493 A1
(43) Pub. Date: May 14, 2009

(54) CATALYST FOR PURIFYING EXHAUST GAS AND METHOD FOR PRODUCING TETRAGONAL SYSTEM COMPOSITE OXIDE

(75) Inventors: Yuunosuke NAKAHARA, Ageo-shi (JP); Katsuya Furumura, Ageo-Shi (JP)

Correspondence Address: YOUNG & THOMPSON, 209 Madison Street, Suite 500, ALEXANDRIA, VA, 22314, US

(73) Assignee: MITSUI MINNG & SMELTING CO., LTD., TOKYO (JP)

(21) Appl. No.: 12/352,231

(22) Filed: Jan. 12, 2009

Related U.S. Application Data
(62) Division of application No. 10/553,005, filed on Jun. 23, 2006.

(30) Foreign Application Priority Data
Apr. 10, 2003 (JP) 2003-107152
Mar. 29, 2004 (JP) 2004-096130

(51) Int. Cl. B01J 23/34

(52) U.S. Cl. 502/324

(57) ABSTRACT

The present invention provides an exhaust gas cleaning catalyst containing a tetragonal-system composite oxide which is produced through a neutralization coprecipitation-drying-firing method and which is represented by A₂BO₄ (wherein A represents at least one member selected from the group consisting of Ca, Sr, and Ba; and B represents at least one member selected from the group consisting of Mn, Fe, Ti, Sn, and V), and a noble metal component which is present in the tetragonal-system composite oxide as a solid solution or which is carried by the composite oxide. The invention also provides a method for producing the tetragonal-system composite oxide. The exhaust gas cleaning catalyst exhibits high catalytic activity at low temperature and excellent heat resistance, thereby attaining reliable exhaust gas purification performance.

### TECHNICAL FIELD

The present invention relates to a catalyst for cleaning an exhaust gas (hereinafter referred to as an exhaust gas cleaning catalyst) and to a method for producing a tetragonal-system composite oxide. More particularly, the invention relates to an exhaust gas cleaning catalyst which exhibits high catalytic activity at low temperature and excellent heat resistance, thereby reliably providing excellent exhaust gas purification performance (e.g., a catalyst for controlling a hazardous component contained in the exhaust gas discharged by an internal combustion engine used in an automobile or the like), and to a method for producing a tetragonal-system composite oxide.

### BACKGROUND ART

Exhaust gases discharged by internal combustion engines of automobiles and the like contain hazardous components such as hydrocarbon (HC), carbon monoxide (CO), and nitrogen oxides (NOₓ). Conventionally, these hazardous components have been removed from the discharge gases by use of a ternary catalyst, thereby providing non-toxic gases.

Japanese Patent Application Laid-Open (kokai) No. 7-80311 discloses a ternary exhaust gas cleaning catalyst including a substrate, a first layer provided on the substrate, and a second layer provided on the first layer, wherein the first layer contains at least alumina and ZrO₂ which is incorporated in alumina or carried on the surface of the substrate; the second layer contains a perovskite-type composite oxide; and a noble metal is carried by at least one layer of the first and second layers.

The above perovskite-type composite oxide has the drawback that the oxide reacts with other metallic components during use at about 900° C. or higher, thereby considerably reducing catalytic activity. Particularly when the atmosphere is oxygen-deficient with respect to the theoretical air-fuel ratio (i.e., a reducing atmosphere, called a rich atmosphere), the perovskite structure is problematically destructed.

Hitherto, ternary catalysts exhibiting high catalytic activity at low temperature and heat resistance have never been developed. Recently, emission level of exhaust gases has been regulated to very strict standards, and therefore, there is an increasing demand for ternary catalysts exhibiting higher exhaust gas purification performance.

In view of the foregoing, an object of the present invention is to provide a catalyst which exhibits high catalytic activity at low temperature and excellent heat resistance, thereby attaining reliable exhaust gas purification performance. Another object is to provide a method for producing a tetragonal-system composite oxide.

### DISCLOSURE OF THE INVENTION

The present inventors have conducted extensive studies in order to attain the aforementioned objects, and have found that the aforementioned objects can be attained through employment of a noble metal component and a tetragonal-system composite oxide which is produced through a neutralization coprecipitation-drying-firing method and which is represented by A₂BO₄. The present invention has been accomplished on the basis of this finding.

Accordingly, the exhaust gas cleaning catalyst of the present invention comprises a tetragonal-system composite oxide which is produced through a neutralization coprecipitation-drying-firing method and which is represented by A₂BO₄ (wherein A represents at least one member selected from the group consisting of Ca, Sr, and Ba; and B represents at least one member selected from the group consisting of Mn, Fe, Ti, Sn, and V), and a noble metal component which is present in the tetragonal-system composite oxide as a solid solution or which is carried by the composite oxide.

The exhaust gas cleaning catalyst of the present invention may comprise a substrate formed of a ceramic or metallic material, and a layer of the aforementioned exhaust gas cleaning catalyst carried on the carrier. Alternatively, the exhaust gas cleaning catalyst may comprise a substrate formed of a ceramic or metallic material; a layer of the aforementioned tetragonal-system composite oxide or a layer of the aforementioned exhaust gas cleaning catalyst carried on the carrier; and a layer of a porous inorganic refractory oxide carrying a noble metal component, the layer being carried by the layer of the tetragonal-system composite oxide or the layer of the exhaust gas cleaning catalyst. Alternatively, the exhaust gas cleaning catalyst may comprise a substrate formed of a ceramic or metallic material; a layer of the aforementioned tetragonal-system composite oxide or a layer of the aforementioned exhaust gas cleaning catalyst carried on the carrier; and two or more layers of a porous inorganic refractory oxide each carrying a noble metal component, the layers being carried by the layer of the tetragonal-system composite oxide or by the layer of the exhaust gas cleaning catalyst, and the noble metal components carried by the porous inorganic refractory oxide layers differing from one another.

In the exhaust gas cleaning catalyst of the present invention, preferably, the tetragonal-system composite oxide is Ca₂MnO₄; the noble metal component is rhodium, palladium, or platinum; and the inorganic refractory oxide is Al₂O₃, SiO₂, ZrO₂, CeO₂, CeO₂—ZrO₂ composite oxide, or CeO₂—ZrO₂—Al₂O₃ composite oxide.

In the exhaust gas cleaning catalyst of the present invention, preferably, the tetragonal-system composite oxide which is produced through a neutralization coprecipitation-drying-firing method and which is represented by A₂BO₄ is obtained by treating, with an aqueous ammonium carbonate solution, an aqueous solution containing (a) at least one member selected from the group consisting of nitrates of Ca, Sr, or Ba and (b) at least one member selected from the group consisting of nitrates of Mn, Fe, Ti, Sn, or V, to thereby co-precipitate a co-precipitation product including a precursor; subjecting the co-precipitation product to filtration; drying the filtered product; and firing the dried product at 800 to 1,450° C.

The method of the present invention for producing a tetragonal-system composite oxide which is represented by A₂BO₄ (wherein A represents at least one member selected from the group consisting of Ca, Sr, and Ba; and B represents at least one member selected from the group consisting of Mn, Fe, Ti, Sn, and V) is characterized by comprising treating, with an aqueous ammonium carbonate solution, an aqueous solution containing (a) at least one member selected from the group consisting of nitrates of Ca, Sr, or Ba and (b) at least one member selected from the group consisting of nitrates of Mn, Fe, Ti, Sn, or V, thereby to thereby co-precipitate a co-precipitation product including a precursor; subjecting the co-precipitation product to filtration; drying the filtered product; and firing the dried product at 800 to 1,450° C.

The method of the present invention for producing a tetragonal-system composite oxide which is represented by A₂B₁₋ₓCₓO₄ (wherein A represents at least one member selected from the group consisting of Ca, Sr, and Ba; B represents at least one member selected from the group consisting of Mn, Fe, Ti, Sn, and V; C represents a noble metal; and x is 0.01 to 0.5) is characterized by comprising treating, with an aqueous ammonium carbonate solution, an aqueous solution containing (a) at least one member selected from the group consisting of nitrates of Ca, Sr, or Ba and (b) at least one member selected from the group consisting of nitrates of Mn, Fe, Ti, Sn, or V, thereby to thereby co-precipitate a co-precipitation product including a precursor; subjecting the co-precipitation product to filtration; drying the filtered product; and firing the dried product at 800 to 1,450° C.; and immersing the fired product in a basic aqueous solution of a noble metal salt, thereby causing the noble metal to be carried in a predetermined amount by the fired product, followed by firing at 300 to 600° C.

According to the exhaust gas cleaning catalyst of the present invention and the method for producing a tetragonal-system composite oxide, high catalytic activity at low temperature and excellent heat resistance can be attained. Thus, reliable exhaust gas purification performance can be attained.

### BRIEF DESCRIPTION OF THE DRAWINGS

FIG. 1 is a graph showing the relationship between amount of oxygen occluded in 1 g of powder sample and temperature, wherein the tetragonal-system composite oxide of the present invention and a tetragonal-system composite oxide produced through a mixing-firing method are employed as samples.

FIG. 2 is a graph showing the relationship between amount of oxygen occluded in 1 g of powder sample and temperature, wherein the tetragonal-system composite oxide of the present invention and a conventional tetragonal-system composite oxide are employed as samples.

### BEST MODES FOR CARRYING OUT THE INVENTION

Embodiments of the present invention will now be described in detail.

The exhaust gas cleaning catalyst of the present invention comprises a tetragonal-system composite oxide which is produced through a neutralization coprecipitation-drying-firing method and which is represented by A₂BO₄ (wherein A represents at least one member selected from the group consisting of Ca, Sr, and Ba; and B represents at least one member selected from the group consisting of Mn, Fe, Ti, Sn, and V), and a noble metal component which is present in the tetragonal-system composite oxide as a solid solution or which is carried by the composite oxide.

The aforementioned neutralization coprecipitation-drying-firing method includes, for example, treating, with an aqueous ammonium carbonate solution, an aqueous solution containing (a) at least one member selected from the group consisting of nitrates of Ca, Sr, or Ba and (b) at least one member selected from the group consisting of nitrates of Mn, Fe, Ti, Sn, or V, thereby to thereby co-precipitate a co-precipitation product including a precursor; subjecting the co-precipitation product to filtration; drying the filtered product; and firing the dried product at 800 to 1,450° C.

The exhaust gas cleaning catalyst of the present invention essentially employs the aforementioned tetragonal-system composite oxide produced through the neutralization coprecipitation-drying-firing method. As is clear from the data of the samples obtained in the below-mentioned Examples and Comparative Examples, the effects of the oxides remarkably depends on the method for producing a tetragonal-system composite oxide; i.e., whether the method is neutralization coprecipitation-drying-firing or mixing-drying-firing.

Examples of the aforementioned tetragonal-system composite oxide represented by A₂BO₄ (wherein A represents at least one member selected from the group consisting of Ca, Sr, and Ba; and B represents at least one member selected from the group consisting of Mn, Fe, Ti, Sn, and V) include Ca₂MnO₄, Sr₂MnO₄, Sr₂FeO₄, Ba₂SnO₄, and Sr₂VO₄. Among them, Ca₂MnO₄ is particularly preferred, from the viewpoint of catalytic activity.

In contrast to perovskite-type composite oxides, which have a cubic crystal system, the aforementioned tetragonal-system composite oxide has a K₂NiF₄-type structure (i.e., tetragonal-system structure), and thus has a large volume of intralattice space. Therefore, the tetragonal-system composite oxide is able to store oxygen in an amount greater than the stoichiometric amount, and incorporated oxygen can readily be released from the lattice, whereby remarkably high oxygen storage performance can be attained. Specifically, the oxygen storage performance is remarkably higher than that of perovskite oxides and OSC material (CeO₂—ZrO₂ composite oxide).

Since the exhaust gas cleaning catalyst of the present invention employs such a tetragonal-system composite oxide, the catalyst is adaptable to a wide range of exhaust gas atmospheres. Specifically, oxygen can readily be stored in or released from the composite oxide in a wide range of oxygen concentration; i.e., from an atmosphere where oxygen is deficient with respect to the theoretical air-fuel ratio (i.e., a reducing atmosphere, called a rich atmosphere) to an atmosphere where oxygen is excess with respect to the theoretical air-fuel ratio (i.e., an oxidizing atmosphere, called a lean atmosphere).

Such easy incorporation and release of oxygen may be attributed to ready occurrence of valence change in elements of A₂BO₄, particularly B site ions, and a large volume of intralattice space. Since oxygen is readily stored in and released from the composite oxide, a large number of reaction sites where a substance to be cleaned is reacted with oxygen are ensured, thereby enhancing reactivity and leading to enhanced catalytic activity. Thus, exhaust gas purification performance can be enhanced.

In addition, the tetragonal-system composite oxide also has excellent heat resistance. Thus, even when the exhaust gas cleaning catalyst is employed at high temperature, remarkably high oxygen storage performance can be attained, leading to enhancement in catalytic activity and exhaust gas purification performance.

The exhaust gas cleaning catalyst of the present invention is formed of the aforementioned tetragonal-system composite oxide and a noble metal component which is present in the tetragonal-system composite oxide as a solid solution or which is carried by the composite oxide. The exhaust gas cleaning catalyst may be produced by immersing the aforementioned tetragonal-system composite oxide in a basic aqueous solution of a noble metal salt, thereby causing the noble metal to be carried in a predetermined amount by the fired product, followed by firing at 300 to 600° C. However, in the exhaust gas cleaning catalyst of the present invention, the issue of whether the noble metal component forms a solid solution or is carried by the composite oxide does not present a severe problem. In any case, or in a state where a noble metal solid solution and carried noble metal co-exist, the exhaust gas cleaning catalysts exhibit the same catalytic effect.

The state where the noble metal component is present as a solid solution in the tetragonal-system composite oxide refers to a state where the B-site element(s) of the tetragonal-system composite oxide is partially substituted by a noble metal component serving as a catalyst active component (e.g., palladium component). Examples of the solid solution include Ca₂Mn₁₋ₓPdₓO₄, Sr₂Fe₁₋ₓPdₓO₄, and Sr₂Mn₁₋ₓPdₓO₄. Through forming a solid solution of a noble metal component (e.g., Pd) in the structure of the tetragonal-system composite oxide, with the component being uniformly dispersed in the oxide, a large number of catalytic active sites can be provided, and reliable exhaust gas purification performance can be ensured.

As described above, the exhaust gas cleaning catalyst of the present invention comprises a tetragonal-system composite oxide and a noble metal component. However, generally, the exhaust gas cleaning catalyst of the present invention comprises a substrate (for example, a carrier) formed of a ceramic or metallic material, and a layer of the aforementioned exhaust gas cleaning catalyst carried on the carrier. Alternatively, the exhaust gas cleaning catalyst comprises a substrate formed of a ceramic or metallic material; a layer of the aforementioned tetragonal-system composite oxide or a layer of the aforementioned exhaust gas cleaning catalyst carried on the carrier; and a layer of a porous inorganic refractory oxide carrying a noble metal component, the layer being carried by the layer of the tetragonal-system composite oxide or the layer of the exhaust gas cleaning catalyst. Alternatively, the exhaust gas cleaning catalyst comprises a substrate formed of a ceramic or metallic material; a layer of the aforementioned tetragonal-system composite oxide or a layer of the aforementioned exhaust gas cleaning catalyst carried on the carrier; and two or more layers of a porous inorganic refractory oxide each carrying a noble metal component, the layers being carried by the layer of the tetragonal-system composite oxide or by the layer of the exhaust gas cleaning catalyst, and the noble metal components carried by the porous inorganic refractory oxide layers differing from one another.

In the aforementioned exhaust gas cleaning catalysts, no particular limitation is imposed on the shape of the carrier formed of a ceramic or metallic material, and the carrier generally assumes a honeycomb shape, in the form of pellets, etc. Of these, a honeycomb shape is preferred. Examples of the material of the carrier include ceramic materials such as alumina (Al₂O₃), mullite (3Al₂O₃-2SiO₂), and cordierite (2MgO-2Al₂O₃-5SiO₂); and metallic materials such as stainless steel. Among them, cordierite is particularly effective, by virtue of its thermal expansion coefficient being as remarkably low as 1.0×10⁻⁵/° C.

The aforementioned layer of the tetragonal-system composite oxide or the layer of the exhaust gas cleaning catalyst, which is carried by the carrier formed of a ceramic or metallic material, may be formed by applying a slurry containing the tetragonal-system composite oxide or the exhaust gas cleaning catalyst to the carrier so as to form a wash coat, followed by drying and firing. The layer of the exhaust gas cleaning catalyst may be formed by forming on the carrier the layer of the exhaust gas cleaning catalyst, and immersing the carrier in a basic solution of a noble metal salt, thereby causing the noble metal to be carried in a predetermined amount by the oxide layer, followed by firing at 300 to 600° C.

The layer of a porous inorganic refractory oxide carrying a noble metal component (e.g., platinum-on-porous alumina), which is carried on the layer of the tetragonal-system composite oxide or the layer of the exhaust gas cleaning catalyst, is formed by causing the noble metal component to be carried by the porous inorganic refractory oxide; subsequently, applying a slurry containing the porous inorganic refractory oxide carrying the noble metal component so as to form a wash coat on the layer of the tetragonal-system composite oxide or the layer of the exhaust gas cleaning catalyst; drying; and firing. Alternatively, the layer of a porous inorganic refractory oxide carrying a noble metal component may be formed by forming a layer of a porous inorganic refractory oxide; and subsequently, immersing the oxide layer in a basic solution of a noble metal salt, thereby causing the noble metal to be carried in a predetermined amount by the oxide layer; followed by firing at 300 to 600° C. In the case where two or more layers of a porous inorganic refractory oxide each carrying a noble metal are provided, each layer may be formed in the same procedure. In this case, the noble metal components carried by the porous inorganic refractory oxide layers differ from one another.

In the exhaust gas cleaning catalyst of the present invention, preferably, the tetragonal-system composite oxide is Ca₂MnO₄; the noble metal component is rhodium, palladium, or platinum; and the inorganic refractory oxide is Al₂O₃, SiO₂, ZrO₂, CeO₂, CeO₂—ZrO₂ composite oxide, or CeO₂—ZrO₂—Al₂O₃ composite oxide.

The exhaust gas cleaning catalyst of the present invention exhibits excellent heat resistance and high catalytic activity at low temperature, even when it is used in a wide gas temperature range of low temperature (i.e., immediately after starting an internal combustion engine of automobiles and the like) to high temperature (i.e., during continuous operation). Thus, reliable exhaust gas purification performance can be attained.

The method of the present invention for producing a tetragonal-system composite oxide which is represented by A₂BO₄ (wherein A represents at least one member selected from the group consisting of Ca, Sr, and Ba; and B represents at least one member selected from the group consisting of Mn, Fe, Ti, Sn, and V) comprises treating, with an aqueous ammonium carbonate solution, an aqueous solution containing (a) at least one member selected from the group consisting of nitrates of Ca, Sr, or Ba and (b) at least one member selected from the group consisting of nitrates of Mn, Fe, Ti, Sn, or V, thereby to thereby co-precipitate a co-precipitation product including a precursor; subjecting the co-precipitation product to filtration; drying the filtered product; and firing the dried product at 800 to 1,450° C.

In the above production method of the present invention, when the aqueous solution containing a nitrate is treated with an aqueous ammonium carbonate solution, the aqueous solution containing a nitrate may be added to an aqueous ammonium carbonate solution. Alternatively, an aqueous ammonium carbonate solution may be added to the aqueous solution containing a nitrate.

The method of the present invention for producing a tetragonal-system composite oxide which is represented by A₂B₁₋ₓCₓO₄ (wherein A represents at least one member selected from the group consisting of Ca, Sr, and Ba; B represents at least one member selected from the group consisting of Mn, Fe, Ti, Sn, and V; C represents a noble metal; and x is 0.01 to 0.5) comprises treating, with an aqueous ammonium carbonate solution, an aqueous solution containing (a) at least one member selected from the group consisting of nitrates of Ca, Sr, or Ba and (b) at least one member selected from the group consisting of nitrates of Mn, Fe, Ti, Sn, or V, thereby to thereby co-precipitate a co-precipitation product including a precursor; subjecting the co-precipitation product to filtration; drying the filtered product; and firing the dried product at 800 to 1,450° C.; and immersing the fired product in a basic aqueous solution of a noble metal salt (e.g., tetraamminepalladium dichloride, tetraamminepalladium hydroxide, tetraammineplatinum hydroxide, or hexaamminerhodium hydroxide), thereby causing the noble metal to be carried in a predetermined amount by the fired product, followed by firing at 300 to 600° C.

In the above production method of the present invention, when the aqueous solution containing a nitrate is treated with an aqueous ammonium carbonate solution, the aqueous solution containing a nitrate may be added to an aqueous ammonium carbonate solution. Alternatively, an aqueous ammonium carbonate solution may be added to the aqueous solution containing a nitrate. According to the above production method of the present invention, when the dried precursor is fired at 300 to 600° C., at least a portion of the noble metal component forms a solid solution in the tetragonal-system composite oxide. Thus, in the above production method of the present invention, in some cases, the entire noble metal component forms a solid solution in the tetragonal-system composite oxide, and in other cases, a portion of the noble metal component forms a solid solution in the tetragonal-system composite oxide, and the other portion is carried by the tetragonal-system composite oxide.

When “x,” representing the amount of noble metal component which forms the above solid solution, is less than 0.01, the catalytic effect attributed to the noble metal component is insufficient, whereas when the value is in excess of 0.5, an effect commensurate with the cost cannot be attained. Thus, the tetragonal-system composite oxide represented by A₂B₁₋ₓCₓO₄ which is produced according to the present invention and employed as the exhaust gas cleaning catalyst of the present invention preferably has an x value of 0.01 to 0.5.

The present invention will next be described in detail by way of Examples and Comparative Examples.

### COMPARATIVE EXAMPLE 1

MnCO₃ powder and CaCO₃ powder (mole ratio, 1:2) were placed in pure water and the mixture was stirred, followed by drying at about 120° C. The dried product was fired at about 1,100° C., to thereby produce Ca₂MnO₄ powder. Formation of Ca₂MnO₄ was confirmed through XRD. Subsequently, a slurry was prepared from the thus-produced Ca₂MnO₄ powder and applied to the surface of a honeycomb-shape porous alumina carrier (600 cells/inch², 25.4 mm×30 mm) by wash-coating. The slurry-coated alumina carrier was dried at about 120° C. and fired at about 500° C., to thereby form a first catalyst layer. A slurry containing platinum-on-alumina which was produced by causing a platinum component to be carried on porous alumina was applied to the first catalyst layer by wash-coating. The slurry-coated alumina carrier was dried at about 120° C. and fired at about 500° C., to thereby form a second catalyst layer. A slurry containing rhodium-on-alumina which was produced by causing a rhodium component to be carried on porous alumina was applied to the second catalyst layer by wash-coating. The slurry-coated alumina carrier was dried at about 120° C. and fired at about 500° C., to thereby form a third catalyst layer. Through the above procedure, an exhaust gas cleaning catalyst was obtained. In the exhaust gas cleaning catalyst, the amount of the platinum component and that of the rhodium component were controlled to attain a concentration of 0.2 g/L-catalyst.

### EXAMPLE 1

An aqueous solution containing manganese(II) nitrate hexahydrate and calcium nitrate tetrahydrate (mole ratio, 1:2) was added dropwise to an aqueous ammonium carbonate solution, to thereby precipitate a precursor. The precursor was filtered out, dried at about 120° C., and fired at about 800° C., to thereby produce Ca₂MnO₄ powder. Formation of Ca₂MnO₄ was confirmed through XRD. Subsequently, a slurry was prepared from the thus-produced Ca₂MnO₄ powder and applied to the surface of a honeycomb-shape porous alumina carrier (600 cells/inch², 25.4 mm×30 mm) by wash-coating. The slurry-coated alumina carrier was dried at about 120° C. and fired at about 500° C., to thereby form a first catalyst layer. A slurry containing platinum-on-alumina which was produced by causing a platinum component to be carried on porous alumina was applied to the first catalyst layer by wash-coating. The slurry-coated alumina carrier was dried at about 120° C. and fired at about 500° C., to thereby form a second catalyst layer. A slurry containing rhodium-on-alumina produced by causing a rhodium component to be carried on porous alumina was applied to the second catalyst layer by wash-coating. The slurry-coated alumina carrier was dried at about 120° C. and fired at about 500° C., to thereby form a third catalyst layer. Through the above procedure, an exhaust gas cleaning catalyst falling within the scope of the present invention was obtained. In the exhaust gas cleaning catalyst, the amount of the platinum component and that of the rhodium component were controlled to attain a concentration of 0.2 g/L-catalyst.

### EXAMPLE 2

An aqueous solution containing manganese(II) nitrate hexahydrate and calcium nitrate tetrahydrate (mole ratio, 1:2) was added dropwise to an aqueous ammonium carbonate solution, to thereby precipitate a precursor. The precursor was filtered out, dried at about 120° C., and fired at about 800° C., to thereby produce Ca₂MnO₄ powder. Formation of Ca₂MnO₄ was confirmed through XRD. The thus-produced Ca₂MnO₄ was immersed in an aqueous tetraamminepalladium solution for so as to cause a predetermined amount of a palladium component to be carried by Ca₂MnO₄. Subsequently, the product was fired at 300° C., to thereby yield a composite oxide containing palladium in which at least a portion of palladium atoms formed a solid solution in the composite oxide. Subsequently, a slurry containing the composite oxide in which a solid-solution-form palladium was present was applied to the surface of a honeycomb-shape porous alumina carrier (600 cells/inch², 25.4 mm×30 mm) by wash-coating. The slurry-coated alumina carrier was dried at about 120° C. and fired at about 500° C., to thereby form a first catalyst layer. Through the above procedure, an exhaust gas cleaning catalyst falling within the scope of the present invention was obtained. In the exhaust gas cleaning catalyst, 5% of manganese atoms were substituted by palladium atoms (i.e., x=0.05). The amount of palladium was controlled to attain a concentration of 1.0 g/L-catalyst.

### EXAMPLE 3

A slurry containing platinum-on-alumina which was produced by causing a platinum component to be carried on porous alumina was applied to the first catalyst layer of the exhaust gas cleaning catalyst produced in Example 2 by wash-coating. The slurry-coated alumina carrier was dried, followed by firing at about 500° C., to thereby form a second catalyst layer. Through the above procedure, an exhaust gas cleaning catalyst falling within the scope of the present invention was obtained. In the exhaust gas cleaning catalyst, the amount of the platinum component and that of palladium were controlled to attain concentrations of 0.2 g/L-catalyst and 1.0 g/L-catalyst, respectively.

### EXAMPLE 4

A slurry containing rhodium-on-alumina which was produced by causing a rhodium component to be carried on porous alumina was applied to the second catalyst layer of the exhaust gas cleaning catalyst produced in Example 3 by wash-coating. The slurry-coated alumina carrier was dried, followed by firing at about 500° C., to thereby form a third catalyst layer. Through the above procedure, an exhaust gas cleaning catalyst falling within the scope of the present invention was obtained. In the exhaust gas cleaning catalyst, the amount of the platinum component and that of the rhodium component were controlled to attain a concentration of 0.2 g/L-catalyst. The amount of palladium was controlled to attain a concentration of 1.0 g/L-catalyst.

### COMPARATIVE EXAMPLE 2 AND EXAMPLES 5 TO 8

The procedures of Comparative Example 1 and Examples 1 to 4 were repeated, except that the first catalyst layer of each of the Comparative Example and the Examples was formed from the composite oxide listed in Table 1, to thereby produce exhaust gas cleaning catalysts shown in Table 1.

### COMPARATIVE EXAMPLE 3

A slurry containing alumina powder was applied to the surface of a honeycomb-shape porous alumina carrier (600 cells/inch², 25.4 mm×30 mm) by wash-coating. The slurry-coated alumina carrier was dried at about 120° C. and fired at about 500° C., to thereby form a first catalyst layer. A slurry containing platinum-on-alumina which was produced by causing a platinum component to be carried on porous alumina was applied to the first catalyst layer by wash-coating. The slurry-coated alumina carrier was dried at about 120° C. and fired at about 500° C., to thereby form a second catalyst layer. A slurry containing rhodium-on-alumina which was produced by causing a rhodium component to be carried on porous alumina was applied to the second catalyst layer by wash-coating. The slurry-coated alumina carrier was dried at about 120° C. and fired at about 500° C., to thereby form a third catalyst layer. Through the above procedure, an exhaust gas cleaning catalyst was obtained. In the exhaust gas cleaning catalyst, the amount of the platinum component and that of the rhodium component were controlled to attain a concentration of 0.2 g/L-catalyst.

### COMPARATIVE EXAMPLES 4 To 6

The procedures of Examples 2 to 4 were repeated, except that the first catalyst layer was formed from palladium-on-alumina produced by causing a palladium component to be carried by porous instead of from the composite oxide employed in Examples 2 to 4 and containing palladium in the form of a solid solution in the oxide, to thereby produce exhaust gas cleaning catalysts shown in Table 1.

### COMPARATIVE EXAMPLE 7

An aqueous solution containing lanthanum nitrate hexahydrate and iron(III) nitrate nanohydrate (mole ratio, 1:1) was added dropwise to an aqueous ammonium carbonate solution, to thereby precipitate a precursor. The precursor was filtered out, dried at about 120° C., and fired at about 700° C., to thereby produce LaFeO₃ powder. The thus-produced LaFeO₃ was immersed in an aqueous tetraamminepalladium solution for so as to cause a predetermined amount of a palladium component to be carried by LaFeO₃. Subsequently, the product was fired at 300° C., to thereby yield a composite oxide containing palladium in which palladium formed a solid solution in the composite oxide. Subsequently, the procedure of Comparative Example 3 was repeated, except that a slurry containing the composite oxide in which a solid-solution-form palladium was present was used instead of the slurry containing alumina powder, to thereby produce an exhaust gas cleaning catalyst shown in Table 1. In the exhaust gas cleaning catalyst, the amount of the platinum component and that of the rhodium component were controlled to attain a concentration of 0.2 g/L-catalyst. The amount of palladium was controlled to attain a concentration of 1.0 g/L-catalyst.

### <Exhaust Gas Purification Performance Test>

Exhaust gas cleaning catalysts of Examples 1 to 8 and Comparative Examples 1 to 7 were evaluated in terms of exhaust gas purification performance.

The three models gases having the following compositions were prepared.

| A/F | CO | O₂ | H₂ | NO | C₃H₆ | CO₂ | H₂ | N₂ |
|---|---|---|---|---|---|---|---|---|
| 15.6 | 0.50% | 1.54% | 0.17% | 500 ppm | 400 ppm | 14% | 10% | balance |
| 14.6 | 0.50% | 0.50% | 0.17% | 500 ppm | 400 ppm | 14% | 10% | balance |
| 13.6 | 2.11% | 0.50% | 0.70% | 500 ppm | 400 ppm | 14% | 10% | balance |

In evaluation of the exhaust gas cleaning catalysts of Examples 1 to 8 and Comparative Examples 1 to 7, two catalyst samples were tested in each case. One sample was attached to a 2000-cc engine and heated at 950° C. for 100 hours under such conditions that A/F fell within a range of 13.6 to 15.6.

Each of the exhaust gas cleaning catalyst samples of Examples 1 to 8 and Comparative Examples 1 to 7 which had not undergone heat treatment (labeled “before heating” in Table 2 below) and the exhaust gas cleaning catalyst samples of Examples 1 to 8 and Comparative Examples 1 to 7 which had undergone heat treatment (labeled “after heating” in Table 2 below) was set in an evaluation apparatus. The temperature of the apparatus was elevated at 20° C./min to 400° C., during which the above three model gases were sequentially and periodically introduced, with one cycle of sequential flow of the three model gases taking one second. Percent removal of CO, HC, and NOₓ were continuously determined. The temperature at which 50% of the model gases was removed (T50, ° C.) and percent removal of model gases at 400° C. (η400, %) are shown in Table 2.

TABLE 1

| | | | | Noble metal | | |
|---|---|---|---|---|---|---|
| | Catalyst layer components | | | component | | |
| | | Second catalyst | Third catalyst | (g/L) | | |
| | First catalyst layer | layer | layer | Pt | Pd | Rh |
| Comparative Example 1 (mixing-firing) | Ca₂MnO₄ | Pt/Al₂O₃ | Rh/Al₂O₃ | 0.2 | — | 0.2 |
| Example 1 (coprecipitation-firing) | Ca₂MnO₄ | Pt/Al₂O₃ | Rh/Al₂O₃ | 0.2 | — | 0.2 |
| Example 2 (coprecipitation-firing) | Ca₂Mn₁₋ₓPdₓOₓ₄ | — | — | — | 1.0 | — |
| Example 3 (coprecipitation-firing) | Ca₂Mn₁₋ₓPdₓOₓ₄ | Pt/Al₂O₃ | — | 0.2 | 1.0 | — |
| Example 4 (coprecipitation-firing) | Ca₂Mn₁₋ₓPdₓOₓ₄ | Pt/Al₂O₃ | — | 0.2 | 1.0 | 0.2 |
| Comparative Example 2 (mixing-firing) | Sr₂FeO₄ | Pt/Al₂O₃ | Rh/Al₂O₃ | 0.2 | — | 0.2 |
| Example 5 (coprecipitation-firing) | Sr₂FeO₄ | Pt/Al₂O₃ | Rh/Al₂O₃ | 0.2 | — | 0.2 |
| Example 6 (coprecipitation-firing) | Sr₂Fe₁₋ₓPdₓOₓ₄ | — | — | — | 1.0 | — |
| Example 7 (coprecipitation-firing) | Sr₂Fe₁₋ₓPdₓOₓ₄ | Pt/Al₂O₃ | — | 0.2 | 1.0 | — |
| Example 8 (coprecipitation-firing) | Sr₂Fe₁₋ₓPdₓOₓ₄ | Pt/Al₂O₃ | Rh/Al₂O₃ | 0.2 | 1.0 | 0.2 |
| Comparative Example 3 | Al₂O₃ | Pt/Al₂O₃ | Rh/Al₂O₃ | 0.2 | — | 0.2 |
| Comparative Example 4 | Pd/Al₂O₃ | — | — | — | 1.0 | — |
| Comparative Example 5 | Pd/Al₂O₃ | Pt/Al₂O₃ | — | 0.2 | 1.0 | — |
| Comparative Example 6 | Pd/Al₂O₃ | Pt/Al₂O₃ | Rh/Al₂O₃ | 0.2 | 1.0 | 0.2 |
| Comparative Example 7 (coprecipitation-firing) | LaFe₁₋ₓPdₓOₓ₃ | Pt/Al₂O₃ | Rh/Al₂O₃ | 0.2 | 1.0 | 0.2 |

*) x of the composite oxides forming the first catalyst layer is 0.05.

TABLE 2

| | T50 (° C.) | | | | | | η400 (%) | | | | | |
|---|---|---|---|---|---|---|---|---|---|---|---|---|
| | CO | | HC | | NOx | | CO | | HC | | NOx | |
| | before | after | before | after | before | after | before | after | before | after | before | after |
| | heating | heating | heating | heating | heating | heating | heating | heating | heating | heating | heating | heating |
| Comparative | 261 | 296 | 273 | 305 | 257 | 256 | 94.8 | 61.3 | 99.2 | 98.3 | 99.6 | 78.6 |
| Example 1 | | | | | | | | | | | | |
| Example 1 | 238 | 258 | 230 | 270 | 225 | 230 | 96.5 | 70.3 | 99.3 | 99.5 | 99.8 | 84.7 |
| Example 2 | 245 | 260 | 235 | 266 | 261 | 267 | 95.5 | 68.8 | 99.0 | 98.7 | 65.9 | 38.1 |
| Example 3 | 230 | 255 | 233 | 258 | 240 | 250 | 97.1 | 75.2 | 99.1 | 99.0 | 70.6 | 45.9 |
| Example 4 | 215 | 240 | 223 | 250 | 219 | 225 | 98.6 | 88.1 | 99.3 | 99.1 | 99.7 | 88.3 |
| Comparative | 260 | 325 | 272 | 332 | 261 | 275 | 95.2 | 65.0 | 98.7 | 97.2 | 99.5 | 85.6 |
| Example 2 | | | | | | | | | | | | |
| Example 5 | 241 | 264 | 243 | 284 | 228 | 231 | 95.8 | 69.1 | 99.0 | 99.3 | 99.6 | 86.5 |
| Example 6 | 251 | 280 | 242 | 271 | 270 | 289 | 96.0 | 65.0 | 99.1 | 98.7 | 61.7 | 35.2 |
| Example 7 | 238 | 261 | 240 | 268 | 256 | 263 | 97.6 | 70.2 | 99.1 | 98.0 | 66.2 | 40.1 |
| Example 8 | 228 | 250 | 230 | 263 | 225 | 230 | 98.0 | 82.3 | 99.2 | 99.4 | 99.4 | 87.5 |
| Comparative | 244 | 313 | 245 | 308 | 236 | 241 | 94.5 | 67.0 | 98.4 | 99.2 | 99.2 | 79.1 |
| Example 3 | | | | | | | | | | | | |
| Comparative | 258 | 322 | 251 | 315 | 280 | 310 | 93.8 | 62.0 | 98.9 | 97.2 | 45.3 | 28.4 |
| Example 4 | | | | | | | | | | | | |
| Comparative | 248 | 278 | 245 | 298 | 277 | 280 | 95.5 | 66.0 | 99.0 | 97.5 | 48.0 | 33.2 |
| Example 5 | | | | | | | | | | | | |
| Comparative | 235 | 300 | 240 | 301 | 230 | 235 | 97.3 | 70.3 | 99.1 | 99.0 | 99.3 | 78.3 |
| Example 6 | | | | | | | | | | | | |
| Comparative | 250 | 328 | 259 | 320 | 245 | 250 | 95.3 | 63.3 | 97.0 | 98.0 | 94.1 | 73.0 |
| Example 7 | | | | | | | | | | | | |

As is clear from Table 2 (comparison of Comparative Example 1 with Example 1 and comparison of Comparative Example 2 with Example 5), exhaust gas cleaning catalysts employing a tetragonal-system composite oxide produced through a neutralization coprecipitation-firing method exhibit excellent performance as compared with those employing a tetragonal-system composite oxide produced through a mixing-firing method. Comparisons of Examples 1 to 4 with Comparative Examples 3 to 6, and those of Examples 5 to 8 with Comparative Examples 3 to 6 clearly indicate that exhaust gas cleaning catalysts having a first catalyst layer formed from a tetragonal-system composite oxide produced through a neutralization coprecipitation-firing method exhibit excellent performance as compared with those having a first catalyst layer formed of alumina.

### <Oxygen Storage Performance Test>

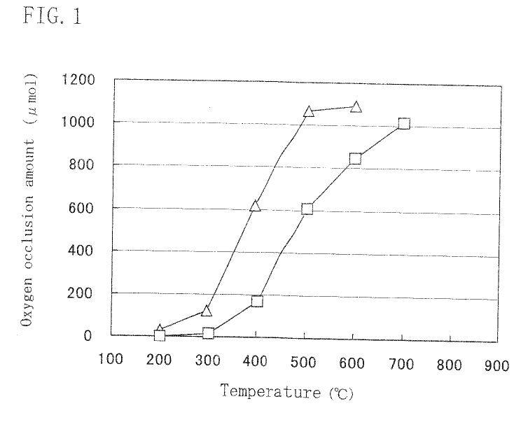

The composite oxide powder containing solid-solution-form palladium and produced through the method employed in Example 2 (neutralization coprecipitation-firing method) (labeled “Inventive” in FIG. 1), and the composite oxide powder containing solid-solution-form palladium and produced by treating, through the method employed in Example 2, the Ca₂MnO₄ powder that had been produced through the method employed in Comparative Example 1 (mixing-firing method) (labeled “Comparative” in FIG. 1) were tested. The relationship between amount of oxygen occluded in 1 g of each powder sample and temperature was investigated. The results are shown in FIG. 1. As is clear from FIG. 1, the tetragonal-system composite oxide employed in the present invention exhibits enhanced oxygen storage performance as compared with the tetragonal-system composite oxide produced through the mixing-firing method.

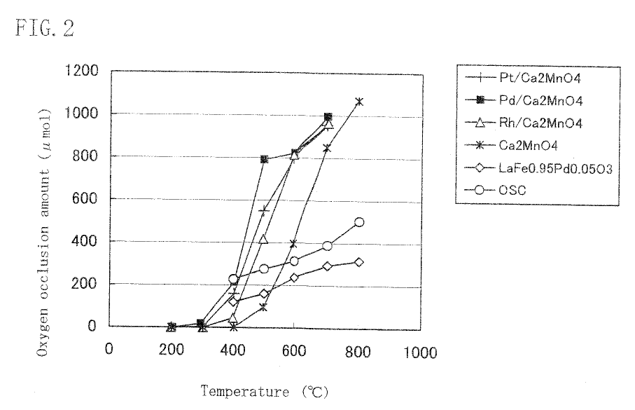

The Ca₂MnO₄ powder produced through the method employed in Example 1; a Pt-on-Ca₂MnO₄ powder produced from Ca₂MnO₄ powder; a Pd-on-Ca₂MnO₄ powder produced from Ca₂MnO₄ powder; an Rh-on-Ca₂MnO₄ powder produced from Ca₂MnO₄ powder; an LaFe_{0.95}Pd_{0.05}O₃ powder; and an OSC (CeO₂—ZrO₂ composite oxide) powder were tested. The relationship between amount of oxygen occluded in 1 g of each powder sample and temperature was investigated. The results are shown in FIG. 2. As is clear from FIG. 2, in the temperature range of 600° C. or higher, the Ca₂MnO₄ powder carrying no noble metal exhibits excellent oxygen storage performance as compared with the Pd-containing LaFe_{0.95}Pd_{0.05}O₃ powder and conventional OSC material. In addition, the oxygen storage-temperature curve of the Ca₂MnO₄ powder is shifted to a low temperature zone, when the Ca₂MnO₄ powder carries a noble metal. The results indicate that carrying a noble metal enhances catalytic activity at low temperature. Among the investigated noble metals, palladium is the most effective for enhancement of the activity.

1. An exhaust gas cleaning catalyst comprises a substrate formed of a ceramic or metallic material; a layer of a tetragonal-system composite oxide or a layer of an exhaust gas cleaning catalyst, carried on the carrier; and a layer of a porous inorganic refractory oxide carrying a noble metal component, the latter layer being carried by the layer of the tetragonal system composite oxide or the layer of the exhaust gas cleaning catalyst.

2. An exhaust gas cleaning catalyst comprises a substrate formed of a ceramic or metallic material; a layer of a tetragonal-system composite oxide or a layer of an exhaust gas cleaning catalyst, carried on the carrier; and two or more layers of a porous inorganic refractory oxide each carrying a noble metal component, the latter layers being carried by the layer of the tetragonal-system composite oxide or by the layer of the exhaust gas cleaning catalyst, and the noble metal components carried by the porous inorganic refractory oxide layers differing from one another.

3. An exhaust gas cleaning catalyst as described in claim 1, wherein the tetragonal-system composite oxide is Ca₂MnO₄.

4. An exhaust gas cleaning catalyst as described in claim 2, wherein the tetragonal-system composite oxide is Ca₂MnO₄.

5. An exhaust gas cleaning catalyst as described in claim 1, wherein the noble metal component is rhodium, palladium, or platinum.

6. An exhaust gas cleaning catalyst as described in claim 2, wherein the noble metal component is rhodium, palladium, or platinum.

7. An exhaust gas cleaning catalyst as described in claim 1, wherein the inorganic refractory oxide is Al₂, O₃, SiO₂, ZrO₂, CeO₂, CeO₂, —ZrO₂ composite oxide, or CeO₂, —ZrO₂, —Al, O3₃ composite oxide.

8. An exhaust gas cleaning catalyst as described in claim 2, wherein the inorganic refractory oxide is Al₂, O3₃, SiO₂, ZrO₂, CeO₂, CeO₂, —ZrO₂ composite oxide, or CeO₂—ZrO₂−Al₂O₃ composite oxide.

9. An exhaust gas cleaning catalyst as described in claim 1, wherein the inorganic refractory oxide is Al₂, O₃, SiO₂, ZrO₂, CeO₂, CeO₂—ZrO₂ composite oxide, or CeO₂, —ZrO₂, —Al₂O₃ composite oxide.

10. An exhaust gas cleaning catalyst as described in claim 2, wherein the inorganic refractory oxide is Al₂O₃, SiO₂, ZrO₂, CeO₂, CeO₂—ZrO₂ composite oxide, or CeO₂—ZrO₂, —Al₂O₃ composite oxide.

11. An exhaust gas cleaning catalyst as described in claim 1, wherein the tetragonal-system composite oxide which is produced through a neutralization coprecipitation-drying-firing method and which is represented by A₂BO₄ is obtained by treating, with an aqueous ammonium carbonate solution, an aqueous solution containing (a) at least one member selected from the group consisting of nitrates of Ca, Sr, or Ba and (b) at least one member selected from the group consisting of nitrates of Mn, Fe, Ti, Sn, or V, to thereby co precipitate a co-precipitation product including a precursor; subjecting the co-precipitation product to filtration; drying the filtered product; and firing the dried product at 800 to 1,450° C.

12. An exhaust gas cleaning catalyst as described in claim 2, wherein the tetragonal-system composite oxide which is produced through a neutralization coprecipitation-drying-firing method and which is represented by A₂BO₄, is obtained by treating, with an aqueous ammonium carbonate solution, an aqueous solution containing (a) at least one member selected from the group consisting of nitrates of Ca, Sr, or Ba and (b) at least one member selected from the group consisting of nitrates of Mn, Fe, Ti, Sn, or V, to thereby co-precipitate a co-precipitation product including a precursor; subjecting the co-precipitation product to filtration; drying the filtered product; and firing the dried product at 800 to 1,450° C.
